(19) United States
(12) Patent Application Publication
(10) Pub. No.: US 2025/0371179 A1
(43) Pub. Date: Dec. 4, 2025

(54) VALUE CREATION FROM INTERNET OF EVERYTHING DATA

(71) Applicant: Imprenditore Pty Ltd., Sydney (AU)

(72) Inventor: Patrick Jeremy RICE, Brisbane (AU)

(73) Assignee: Imprenditore Pty Ltd., Sydney (AU)

(21) Appl. No.: 19/041,933

(22) Filed: Jan. 30, 2025

Related U.S. Application Data
(60) Provisional application No. 63/627,003, filed on Jan. 30, 2024.

(51) Int. Cl. G06F 21/62; G06F 21/64

(52) U.S. Cl. CPC G06F 21/62; G06F 21/64

(57) ABSTRACT

A system that includes an adaptive exchange (ADX) platform in an Internet of Everything (IoE) ecosystem is disclosed. The ADX platform addresses the challenges of data trading, integrity, and value creation. The ADX platform establishes a secure data-sharing framework through data carnets, facilitating transparent agreements for data exchange. Moreover, the ADX platform ensures data privacy, putting data control back in the hands of owners, effectively inverting the traditional privacy-power dynamic. The ADX platform performs secure computation and generational data creation, assuring data integrity and long-term value. The system empowers data owners to securely share their data collections and earn recurring revenue, fostering a robust, user-centric IoE data ecosystem. In essence, the ADX platform transforms data trading, making data a driving force for innovation in our connected world.

### RELATED APPLICATIONS

This application claims priority to U.S. Provisional Application No. 63/627,003 filed Jan. 30, 2024, the contents of which are incorporated herein by reference.

### FIELD OF TECHNOLOGY

The present disclosure relates generally to internet of everything (IoE) technology, and more specifically, to a method for value creation from IoE data.

### BACKGROUND

In today's data-driven world, the vast proliferation of interconnected devices, sensors, and systems within the Internet of Everything (IoE) has ushered in a new era of unprecedented data generation and exchange. This exponential growth of data has presented both opportunities and challenges. While data holds immense potential to drive innovation, inform decision-making, and improve various aspects of our lives, it has also raised critical concerns related to data privacy, security, and data ownership.

### BRIEF SUMMARY OF THE DISCLOSURE

The present disclosure provides a system and a method for value creation from IoE data. The present disclosure seeks to provide a solution to the existing problem of how to enable secure, efficient, and transparent data trading within an IoE ecosystem. An aim of the present disclosure is to provide a solution that overcomes at least partially the problems encountered in prior art and provide an improved system that provides a data sharing platform that represents a transformative solution that promotes the ideals of open data collaboration, data-driven innovation, and data privacy and an improved method that generates insights and enable data trading. The data sharing platform empowers individuals and organizations to contribute and access data and insights, fostering a collective intelligence approach. The users may share their data pools and monetize their algorithms while maintaining control over their private data. Such user-centric model inverts the traditional privacy-power imbalance, ensuring that data remains in the hands of its rightful owners. The data sharing platform encourages a more equitable and open data ecosystem where data serves as a catalyst for solving broader societal challenges and driving innovation.

It has to be noted that all devices, elements, circuitry, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof. It will be appreciated that features of the present disclosure are susceptible to being combined in various combinations without departing from the scope of the present disclosure as defined by the appended claims.

Additional aspects, advantages, features, and objects of the present disclosure would be made apparent from the drawings and the detailed description of the illustrative implementations construed in conjunction with the appended claims that follow.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a block diagram of a method for value creation from internet of everything (IoE) data, in accordance with an embodiment of the present disclosure.

FIG. 2 is a bar graph illustrating potential cashflow over a period of time for a Special Purpose Vehicle (SPV) according to the present invention.

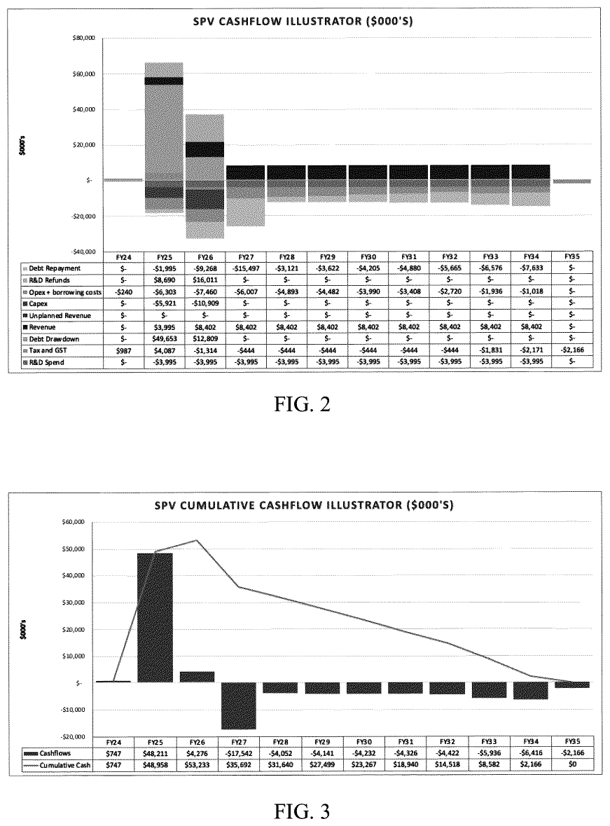

FIG. 3 is a bar graph illustrating potential cumulative cashflow over a period of time for a SPV according to the present invention.

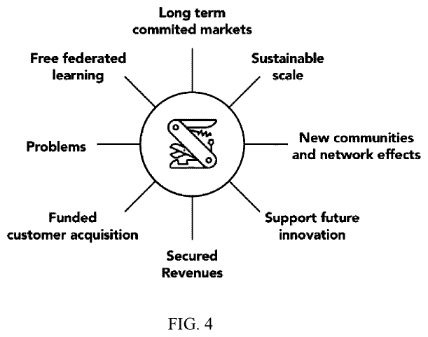

FIG. 4 is a web diagram illustrating potential benefits of for a data exchange model according to the present invention.

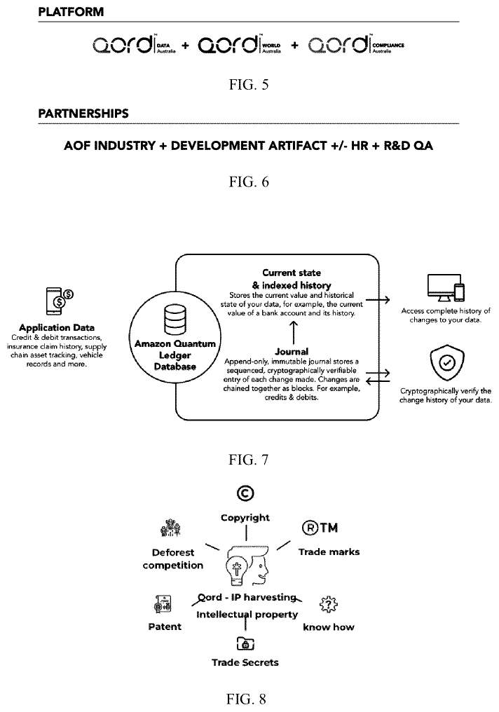

FIG. 5 is a listing of possible platform level hosts for a data exchange model according to the present invention.

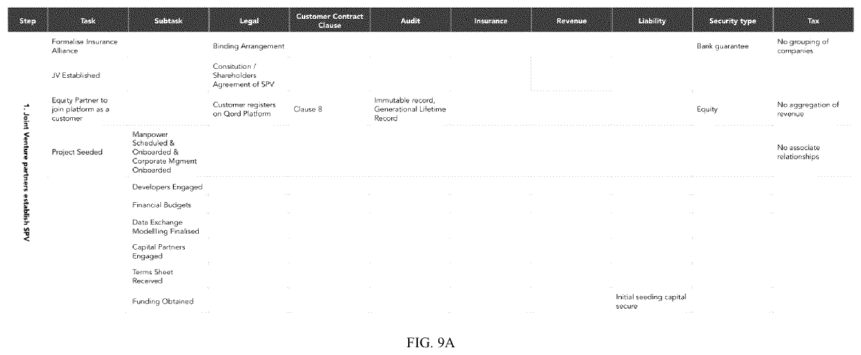

FIG. 6 is a listing of possible partnerships that may be possible under a data exchange model according to the present invention.

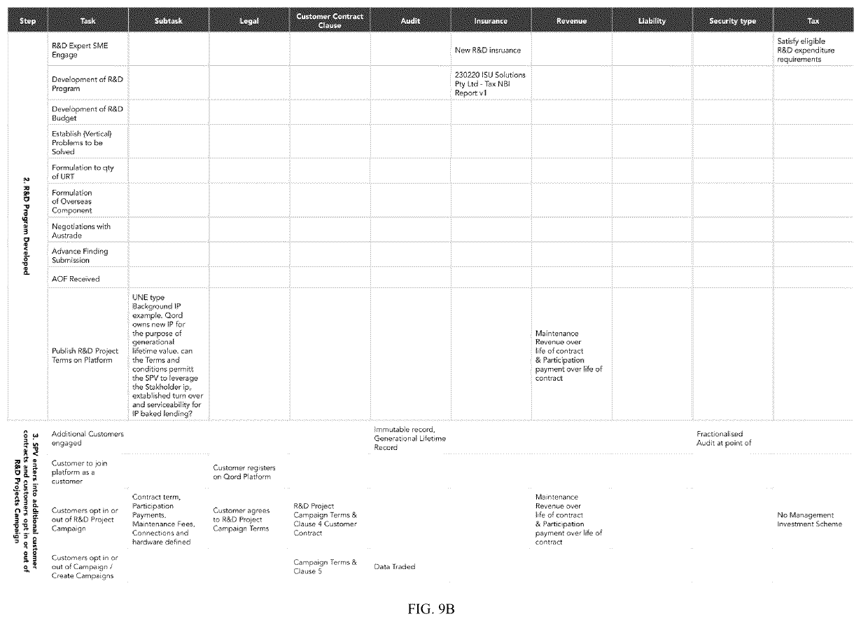

FIG. 7 is a flowchart of possible data flow under a data exchange model according to the present invention.

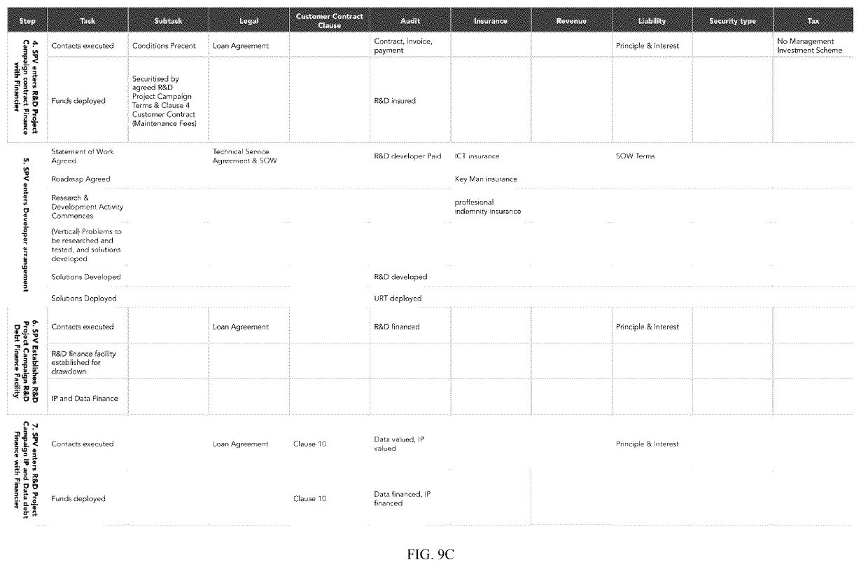

FIG. 8 is a web diagram illustrating potential sources for harvesting intellectual property under a data exchange model according to the present invention.

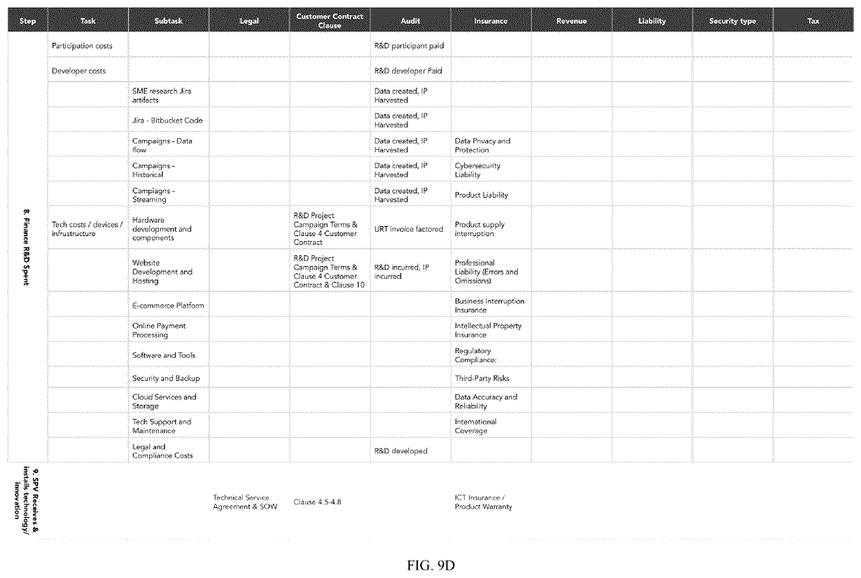

FIGS. 9A-9E is a block diagram of a method for value creation from IoE data under a data exchange model according to the present invention.

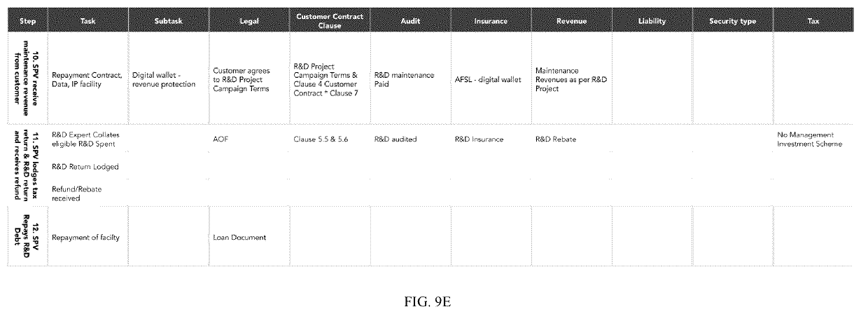

FIG. 10 is a diagram illustrating a possible equity breakdown between a platform and its partners under a data exchange model according to the present invention.

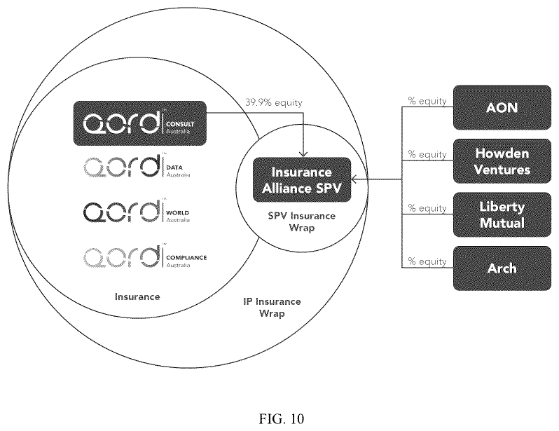

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF THE DISCLOSURE

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

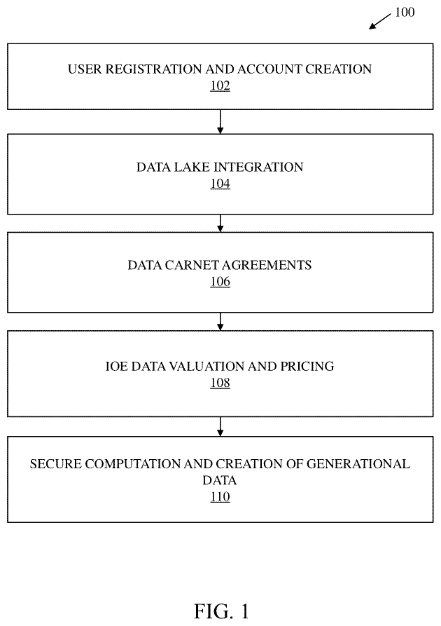

FIG. 1 is a block diagram of a method for value creation from Internet of Everything (IoE) data, in accordance with an embodiment of the present disclosure. Referring to FIG. 1, there is shown a flow chart of a method 100 for value creation from IoE data. The method 100 may include steps 102 to 110. The present disclosure mainly include the secure exchange of the IoE data, the ability to create value from this data, and innovative algorithms or processes for data trading and analysis.

The IoE involves the interconnection of various devices, objects, and sensors, enabling them to collect and exchange data to create value and insights. The types of data that can be part of the IoE ecosystem are diverse and can come from a wide range of sources. Some examples of the IoE data includes smart home data such as temperature and humidity readings from smart thermostats, sensor data from smart doorbells and security cameras, energy consumption data from smart meters, and motion and occupancy data from motion sensors. Examples of the IoE data further include wearable device data such as health data from fitness trackers, including heart rate, step count, and sleep patterns, and location data from GPS-enabled wearables, environmental data, such as exposure to UV radiation or air quality. In some other examples, the IoE data further includes industrial IoT (IIoT) data such as equipment sensor data in manufacturing plants, indicating machine health and performance, supply chain data, including the location and condition of goods in transit, and energy usage data in industrial settings for optimizing efficiency. In some other examples, the IoE data further includes agricultural data such as soil moisture and nutrient levels in precision agriculture, livestock health data, including location and vital signs, and weather data for crop management. In some other examples, the IoE data further includes smart city data such as traffic flow data from smart traffic lights and sensors, environmental data, such as air quality and noise levels, and waste management data for optimizing collection routes. In some other examples, the IoE data further includes healthcare data such as electronic health records (EHR) for patients, including medical history and treatment plans, remote patient monitoring data for chronic condition management, and medication adherence data from smart pill dispensers. In some other examples, the IoE data further includes retail data such as customer behavior data from in-store sensors and cameras, inventory and supply chain data for optimizing stock levels, and sales and transaction data for sales analytics. In some other examples, the IoE data further includes transportation and logistics data such as vehicle telematics data, including location, speed, and fuel consumption, package tracking and delivery data, and data from autonomous vehicles for navigation and safety. In some other examples, the IoE data further includes environmental data such as climate data, including temperature, humidity, and precipitation, pollution data, such as air and water quality measurements, and wildlife tracking data for conservation efforts. In some other examples, the IoE data further includes financial data such as stock market data, including real-time trading information, payment transaction data for fraud detection and financial analytics, and customer spending patterns and behavior. In some other examples, the IoE data further includes social media and web data such as social media interactions, including likes, shares, and comments, web traffic data for website optimization and user behavior analysis, and user-generated content, such as reviews and comments.

The present disclosure provide an integrated adaptive exchange (ADX) platform with the IoE data fractionalization capabilities. At step 102, the method 100 includes registration of a user and creation of an account associated with the user. In this regard, the users create accounts on the ADX platform, undergoing KYC (Know Your Customer) verification to ensure compliance with financial regulations.

At step 104, the method 100 further includes data lake integration. The data lake integration refers to a phase within the data trading platform of an IoE ecosystem. The data lake acts as a secure, centralized repository for private data collections owned by account holders. This integration process encompasses several vital steps. Initially, data is collected and aggregated from diverse sources, ranging from IoE devices to external data providers, reflecting various formats and industry origins. Before being stored in the data lake, data undergoes encryption to ensure its confidentiality and integrity. The data lake further organizes data into distinct silos, facilitating efficient data management and access control. Access permissions are defined by data owners, offering precise control over who can access their data and under what conditions. Data trading, a key feature, allows account holders to negotiate data access with other parties. The data lake integration is stringent in its compliance with data privacy regulations, such as general data protection regulation (GDPR), empowering data owners to revoke access when needed. In terms of security and resilience, the data lake is designed to ensure data remains confidential and accessible in case of system failures. Ultimately, integrated data fuels analytics and insights, enabling data owners and analysts to derive value and make informed decisions. This integration process underpins the data trading platform, assuring data security, privacy, and overall platform functionality.

At step 106, the method 100 further includes preparing data carnet agreements. The data carnet agreements are formal digital contracts that detail the terms and conditions of data exchanges between parties, with the ADX platform facilitating and recording the agreements to ensure data security and transparency. In the data trading process, two parties must reach a mutual agreement on the data's specifics, including its format, utilization, and any associated commercial terms. This agreement, known as the data carnet, is a digitally signed contract encompassing the data provider, data consumer, data schema, commercial terms, data filters, and policy terms. The ADX platform plays a central role in facilitating and executing this agreement, ensuring secure data exchange without exposing personal information. Such data carnet agreements are stored immutably in the quantum ledger database (QLDB), providing a transparent and auditable record of all data and financial transactions within the ADX. To enhance transparency and data resilience, these records can be securely streamed to a private and/or public blockchain (e.g., Ethereum), guaranteeing operational integrity even if the ADX operator ceases to exist. This comprehensive system ensures secure, transparent, and tamper-proof data trading in the ecosystem.

At step 108, the method 100 further includes the IoE data valuation and pricing. The valuation models may be integrated into the ADX platform, allowing data owners to estimate the value of their IoE data or assets. Pricing mechanisms, such as auctions or fixed prices, may be chosen for fractional shares. In some examples, the IoE data valuation and pricing may involve negotiation between the data provider (seller) and the data consumer (buyer). The parties may discuss the terms of the trade, including the price, payment structure, and any additional conditions. In some examples, the commercial terms mentioned in the data carnet (as explained in the previous step) include a set of financial considerations, such as one-time payments, subscription fees, or revenue-sharing arrangements. In some examples, dynamic pricing process is used based on real-time market conditions and demand. This means that the price of data may vary based on factors like demand spikes or changes in data quality. The valuation and pricing process should be transparent to both the data provider and the data consumer. Parties involved should understand how the value of the data was determined and how the pricing structure works. In some implementations, the data valuation and pricing aim to ensure that both parties receive fair compensation for their participation in the data exchange. It should reflect the value of the data to the data consumer and the contribution of the data provider. This step facilitates the monetization of data by allowing data providers to generate revenue from their data assets and data consumers to access valuable data for their needs.

At step 110, the method 100 further includes secure computation and creation of generational data. The secure computation refers to the process by which data acquired through data trading agreements is processed in a secure and protected environment. In detail, account holders acquire new data sources through data trading agreements within the ADX platform. Then, the ADX platform hosts computation processes and verified algorithms or software that are used to process and analyze the acquired data. Such self-contained computation entities ensure that the data remains secure throughout the processing. The computation processes may include data enrichment, filtering, and intelligence gathering, which may result in the creation of new data sets or insights. In addition, the ADX platform and its administrators are not exposed to the actual data being processed. This ensures that the data remains confidential and secure during computation. Once the data has been securely processed, it becomes a part of the generational data. In detail, the resulting data sets, which have undergone secure computations, are now certified generational data sources. Such data sources have been derived from verified computational processes, ensuring data integrity and reliability. Generational data may not be externally manipulated or altered once it has been created. This guarantees the quality and authenticity of the data. The ADX platform maintains an auditable record of the generational data, creating an evolutionary trail that links the processed data back to its original sources. This trail provides transparency and accountability. The data owners of the original sources have the opportunity to earn recurring revenue from these generational data sources. Data trading agreements may specify that a portion of the revenue generated by subsequent data computations is shared back with the original data owners.

In conclusion, the secure computation ensures that data remains confidential and is processed securely within the ADX platform. Generational data, on the other hand, is the result of these secure computations and represents certified, reliable data sources with an auditable history. Data owners can benefit from recurring revenue generated by these generational data sources, and the data remains tamper-proof and dependable.

Beneficially, the ADX platform represents a transformative solution that promotes the ideals of open data collaboration, data-driven innovation, and data privacy. The ADX platform empowers individuals and organizations to contribute and access data and insights, fostering a collective intelligence approach. The users may share their data pools and monetize their algorithms while maintaining control over their private data. Such user-centric model inverts the traditional privacy-power imbalance, ensuring that data remains in the hands of its rightful owners. The data sharing platform encourages a more equitable and open data ecosystem where data serves as a catalyst for solving broader societal challenges and driving innovation.

In some examples, the method further includes leveraging the ADX platform to generate insights and value from diverse data sources by following below steps:
enabling data originators to monetize their data by making it available to parties interested in extracting new insights from it.
providing a platform for combining real-time insights through the integration of various data streams from sensors, APIs, and other systems.
serving as a central hub for aggregating data from multiple sources, allowing for the synthesis of valuable insights.
facilitating the creation of privacy-positive social networks and “gig economy” businesses that respect data privacy.

Some examples of applications within the IoE ecosystem are provided below. In a first example, an IoT-enabled grazier licensing access to location and health data of her animals to a pharmaceutical company for modeling the efficacy of a worming product. In a second example, a logistics company licensing an analysis model for predicting engine and gearbox failure based on engine monitoring data, reducing breakdown incidents. In a third example, farmers contributing data to calculate regional yield averages without revealing individual yield and profit figures. In a fourth example, a rideshare service partnering with a logistics company to optimize empty vehicle use for point-to-point courier deliveries based on vehicle movements and delivery jobs.

The method 100 further includes controlling a display to display activities related to the IoE data fractionalization, IoE data trading, etc. Advantageously, the users have access to a dashboard that displays their asset holdings, earnings from IoE data shares, and IoE data trading activities. In addition, the user may also monitor the performance of their IoE data investments. Further, legal experts may provide templates for the IoE data fractionalization agreements and ensure that all agreements are compliant with relevant securities regulations. Further, robust security measures are in place to protect both the IoE data and financial data of users. Encryption and data access controls ensure the confidentiality and integrity of information. Moreover, a user support system assists users in case of disputes or issues with IoE data fractionalization agreements. The ADX platform provides transparent reporting and auditing features for IoE fractionalization activities, ensuring that all transactions are recorded and auditable. Records of the IoE data fractionalization agreements and transactions may be integrated with external blockchains, providing an immutable, long-term record of activities.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments and/or to exclude the incorporation of features from other embodiments. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the present disclosure, which are, for brevity, described in the context of a single embodiment, may also be provided separately or in any suitable combination or as suitable in any other described embodiment of the disclosure.

The following documents attached to this application provide additional specification and drawings that are an integral part of the present disclosure:

QORD “Data Exchange Explainer”

QORD “Fractionalisation of Innovation and Finance”

QORD “Data Exchange Utility”

QORD “Data Utility Explainer Roadmap to Success”

QORD “Insurance Alliance 2024”

### KEY POINTS

1. A method for value creation from Internet of Everything data is disclosed.

2. Collecting data from a multitude of interconnected devices and sensors in diverse environments, encompassing industrial, agricultural, and consumer contexts.

3. Performing real-time data processing and analysis on the collected data, including data fusion and application of machine learning algorithms to extract insights, patterns, and trends.

4. Offering user interfaces and interaction channels for users to access the system, view real-time data insights, monitor device status, and control connected devices remotely.

5. Providing a centralized control facility that presents users with a comprehensive overview of their interconnected devices and data, enabling efficient management and monitoring of the IoE environment.

6. Implementing data sharing and collaboration functionalities to allow users to share data and insights with other users, third-party services, or external ecosystems, fostering a collaborative and interlinked data environment.

7. Ensuring robust security measures to protect data privacy, encompassing encryption, authentication, access control, and secure data transmission.

8. Enabling a monetization framework that allows users to create value from their IoE data, including revenue-sharing models, value-added services, and wealth generation opportunities.

9. Incorporating scalability and adaptability features that facilitate integration with a wide range of devices, platforms, and industries, ensuring flexibility to meet evolving user needs.

What is claimed is:

1. A system for an internet of everything ecosystem, comprising:
an ADX platform having a secure data-sharing framework through data carnets facilitating transparent agreements for data exchange configured to addresses challenges of data trading, integrity, and value creation, wherein the ADX platform performs secure computation and generational data creation, assuring data integrity and long-term value.
